(19) United States
(12) Patent Application Publication
(10) Pub. No.: US 2008/0255273 A1
(43) Pub. Date: Oct. 16, 2008

(54) Particulate Filled Polymers

(75) Inventors: Frank Ralph Pepe, Fogelsville, PA (US); Denise Luise Lindenmuth, North Wales, PA (US); Charles Raymond Hegedus, Allentown, PA (US); Lisa Ann Mercando, Pennsburg, PA (US); Jennifer Anne Bierkamp, Lenhartsville, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: AIR PRODUCTS AND CHEMICALS, INC., Allentown, PA (US)

(21) Appl. No.: 11/938,903

(22) Filed: Nov. 13, 2007

Related U.S. Application Data
(60) Provisional application No. 60/860,054, filed on Nov. 20, 2006.
(60) Provisional application No. 60/900,623, filed on Feb. 9, 2007.

(51) Int. Cl. C09D 5/00; C08K 3/22; C08K 5/00

(52) U.S. Cl. 524/13; 524/432

(57) ABSTRACT

An aqueous polymeric coating composition having a polymer for forming a polymer matrix having carboxylate functionality and nano-scale zinc oxide particles dispersed in the polymer. The particles provide the polymer with at least partial crosslinking and alcohol resistance when incorporated into the polymer matrix upon curing. A polymeric material formed from the aqueous composition and a coated article are also disclosed.

### CROSS-REFERENCE TO RELATED APPLICATIONS

This application claims the benefit of U.S. Provisional Application No. 60/860,054 filed 20 Nov. 2006 and U.S. Provisional Application No. 60/900,623 filed 9 Feb. 2007, the disclosures of which are incorporated by reference in their entirety.

### BACKGROUND OF THE INVENTION

The instant disclosure relates to weather resistant inorganic nanoparticle dispersion containing materials. The nano-scale particle dispersion containing materials can be used as a UV-absorber, for catalytic applications, electronic applications, corrosion protection coatings, production of antifungal or antibacterial materials, sensors, actuators, photovoltaic devices, conductive coatings, among other applications.

Exposure to ultraviolet (UV) radiation can lead to the degradation of certain materials. There is a need to protect exposed materials against UV and in some cases to avoid transmission of UV radiation through transparent covers or coatings. In order to be used for transparent coatings, UV protecting agents are preferably transparent and, in some cases, colorless in the final application. For some applications or end-uses these agents are permanent, non migratory and stable against degradation. Organic UV protecting agents or absorbers can be migratory and have unacceptable long term stability (e.g., less than 10 years). In some cases organic UV absorbers are not stable against oxidation or at relatively high temperatures. Inorganic UV absorbers (e.g. ZnO, TiO₂, Fe₂O₃, CeO₂, among other inorganic compounds), can have enhanced stability in comparison to organic absorbers. However, inorganic absorbers may not be transparent and/or colorless, or they may be photocatalytically active and in some cases adversely affect a surrounding polymeric matrix when exposed to UV. There is a need in this art for dispersions that can be used as an inorganic transparent UV blocking additive for preparing transparent materials or coatings with low haze levels.

Coatings (clearcoats and pigmented coatings) based on thermoplastic polyurethane polymers typically have relatively poor resistance to alcohols. Further, coatings based on thermoplastic acrylic latex have relatively poor resistance to alcohols. In addition, clearcoats based upon polyurethane polymers can have relatively low resistance to high humidity conditions. Humidity exposure may cause blistering of the coating, loss of coating adhesion, and/or degradation of the substrate (e.g., corrosion of metallic substrates).

What is needed is an at least partially crosslinked coating system utilizing an inorganic UV-absorber that provides coating stability, such as during exposure to humidity and to alcohol exposure.

### BRIEF SUMMARY OF THE INVENTION

One aspect of the present disclosure includes an aqueous polymeric coating composition having a polymer for forming a polymer matrix having carboxylate functionality and nano-scale zinc oxide particles dispersed in the polymer. The particles providing the polymer with at least partial crosslinking and alcohol resistance when incorporated into the polymer matrix upon curing.

Another aspect includes a polymeric material having a polymer matrix having carboxylate functionality and nano-scale zinc oxide particles incorporated therein. The particles provide the material with at least partial crosslinking and alcohol resistance when incorporated into the polymer matrix.

Still another aspect includes a coated article. The article includes a substrate having a polymeric coating thereon. The polymeric coating includes a polymer matrix having carboxylate functionality and nano-scale zinc oxide particles incorporated into the polymer matrix. The particles provide the material with at least partial crosslinking and alcohol resistance when incorporated into the polymer matrix.

Other features and advantages of the present invention will be apparent from the following more detailed description of the preferred embodiment, taken in conjunction with the accompanying drawings which illustrate, by way of example, the principles of the invention.

### BRIEF DESCRIPTION OF SEVERAL VIEWS OF THE DRAWINGS

FIG. 1 is a chart showing temperature vs. modulus for samples according to Examples 1 and 3.

### DETAILED DESCRIPTION OF THE INVENTION

The instant disclosure relates to polymeric coatings and coating systems using particles and particulate dispersions to improve the properties of the coatings, films, and other polymeric materials. In certain embodiments of the disclosure, nano-scale particles (e.g., sub-micron zinc oxide particles) are incorporated into an acrylic-polyurethane hybrid latex coating formulation (e.g., available commercially from Air Products and Chemicals, Inc. as HYBRIDUR® 570). “Nano-scale”, “nano”, “sub-micron” and grammatical variations thereof includes particle diameters that are less than about 1 micron in size. The incorporation of the nano-scale particles causes improvement in alcohol and humidity resistance of the formed coating.

In another embodiment, nano-scale particles may be incorporated into a coating formulation containing a polyurethane dispersion (PUD) and/or acrylic polymer.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the disclosure. This is done merely for convenience and to give a general sense of the disclosure. This description should be read to include one or at least one and the singular also includes the plural unless it is obvious that it is meant otherwise.

“Carboxylate functionality”, “Carboxyl functionality” and grammatical variations include chemical components having the ability to form carboxylate ions for complexing with nano-scale particulates or other cations. For example, while not wishing to be bound by theory, after application of a polymer formulation according to an embodiment to a substrate, water begins to evaporate and the polymer particles begin to coalescence. During this time, the volatile agents present to neutralize the carboxylate ions in the dispersion, such as ammonia or other volatile amines, also evaporate. The carboxylate ions are thereby freed from the neutralizing counterion. The unassociated carboxylate anions then complex with nano-scale zinc oxide particulate and form ionic crosslinks.

“At least partial crosslinking”, “at least partially crosslinked” and grammatical variations thereof include polymers and polymer systems having some amount of polymeric crosslinking.

In one aspect of the disclosure, the polymeric formulation or material comprises polyurethane-vinyl polymers. A description of suitable polyurethane-vinyl polymer dispersions can be found in U.S. Pat. Nos. 5,173,526 and 5,571,857; the disclosure of which are hereby incorporated by reference in their entirety. In addition, the particle dispersions can be added to solvent or water borne coating formulations containing at least one member selected from the group consisting of epoxy functional compounds, alkyds, vinyl chlorides, cellulose, silicones, silanes, melamines, polyethers, polyesters, among other compounds.

In another aspect of the disclosure, the polymeric formulation or material comprises polymer matrix containing at least one member selected from the group consisting of acrylics, vinyl acetates, ethylene-vinyl acetate copolymers, vinyl acetate-acrylic copolymers, and ethylene vinyl chloride copolymers. Examples of such materials are described in U.S. Pat. Nos. 5,500,251 and 3,787,232; the disclosure of which are hereby incorporated by reference in their entirety.

In a further aspect of the disclosure, the polymeric formulation or material comprises a polymeric matrix containing a carboxylic acid functional polymer. While any suitable polymer can be employed, examples of such polymers include, but are not limited to at least one member selected from the group consisting of acrylic, polyurethane, acrylic-urethane hybrids, polyureas, vinyl acetate, ethylene-vinyl acetate, ethylene vinyl chloride, vinyl acetate-acrylic, epoxy, alkyds, cellulose, silicones, silanes, melamines, polyethers, and polyesters.

The amount of nano-scale particles in the film or coating composition, before curing or drying, can range from about 0.1 to about 70 wt. % nano-scale particle to weight of polymer solids of the composition. In other embodiments, the concentration of the nano-scale particles in the coating is from about 0.1 to about 20 wt. % or from about 1 to about 15 wt. %. The amount of particles employed will depend upon the end use. For example, if the nano-scale particles are incorporated into a coating, the amount of nano-scale particles would be sufficient to allow formation of a coating. The nano-scale particles are typically added to the polymer matrix as a dispersion of the nano-scale particles.

Nano-scale particle dispersions and dispersing agents for use in the coating of the present disclosure includes the materials found in copending and commonly assigned U.S. patent application Ser. Nos. 11/524,471, filed on Sep. 21, 2006 and entitled “Use of 2,3-Dihydroxynapththalene-6-Sulfonic Acid Salts As Dispersants” and 11/583,439, filed on Oct. 19, 2006 and entitled “Molecules With Complexing Groups For Aqueous Nanoparticle Dispersions And Uses Thereof”; the disclosure of which are hereby incorporated by reference in its entirety. As used herein, the term “dispersion” refers to a liquid medium comprising a suspension of minute colloid particles. As used herein, the term “colloid” refers to the minute particles suspended in the liquid medium, said particles having a particle size up to about 1 micron (e.g., about 20 nanometers to about 800 nanometers and normally about 30 to about 500 nanometers). The nano-scale particles that can be added to the coating formulation typically comprise zinc oxide. Certain embodiments include nano-scale zinc oxide dispersions having a particle size of about 5 to about 100 nanometers (nm).

The inorganic nano-scale particle dispersion included in the polymeric coatings and coating systems are capable of providing transparency and UV blocking to the coatings or materials in which they are incorporated. The nano-scale particles within the dispersions will normally range in size from about 5 to about 500 nm. In other embodiment, the range may be from about 5 to about 200 nm or from about 25 to about 100 nm. While any suitable dispersion can be combined with the polymer, typically the dispersion will comprise or consist essentially of about 10⁻³ to about 95 wt. % of nano-scale particles and about 0.1 to about 50 wt. % of at least one dispersing agent. In other embodiments, the amount of nano-scale particles includes from about 0.1 wt. % to about 80 wt. % or from about 1 to about 50 wt. % nano-scale particles. Further, the amount of dispersing agent includes from about 0.1 wt. % to about 50 wt. % or from about 1 to about 25 wt. % dispersing agent. Further examples of suitable dispersing agents include, but are not limited to at least one member selected from the group consisting of diammoniumcitrate, catechols (e.g. 4,5-dihydroxy-m-benzenedisulfonic acid disodium salt), certain block copolymers with pigment affinic groups (e.g., BYK® 190), methoxy-ethoxy-ethoxy-acetic acid, oligo- or polyacrylic acids and their compounds, mixtures thereof. In one aspect of the disclosure, the dispersing agent can comprise polyisobutenylsuccinic anhydrides (PIBSA). PIBSA dispersing agents are described in U.S. Patent Application Nos. 60/898,554 and 60/898,555 (Docket Nos. 6931Z and 7059Z), both filed on Jan. 31, 2007; the disclosure of which is hereby incorporated by reference in its entirety.

While the inventive composition can include conventional additives or dispersing agents such as Na-polyphosphate, ascorbic acid, citric acid, 6-aminohexanoic acid, stearic acid and/or salts of polyacrylic acid, in a further aspect of the disclosure, the composition is substantially free of the foregoing compounds. By substantially free of it is meant that the composition comprises less than about 0.1 wt. % of the foregoing dispersing agents.

The dispersion can also comprise at least one carrier or diluent. The carrier can be aqueous (e.g., deionized water), or based upon one or more suitable organic compounds. Examples of suitable organic compounds can comprise at least one member selected from the group consisting of isopropoxyethanol, ethanol, toluene, alcohol, butanol, isoacyl alcohol, cetone, acetone, methyl ethyl ketone (MEK), dicetone, diole, carbitole, glycole, diglycole, triglycole, glycol ether, ethoxy-, propoxy-, isopropoxy-, butoxyethanol-acetate, ester, glycolester, ethyl acetate, butyl acetate, butoxyethyl acetate, alcane, toluene, xylene, acrylic acid, methacrylic acid, acrylate or methacrylate monomers as well as their derivatives, among other suitable substrates. The amount of carrier can range from about <10 wt. % to about 99 wt. % of the dispersion.

The dispersions can be prepared by any suitable methods such as stirring, shaking, all kinds of milling, e.g. media milling, three roll milling, high speed dispersing, rotor stator techniques, sonication, jet milling, to name a few applicable techniques

In certain embodiments of the disclosure, the polymeric matrix material containing the nano-scale particles are transparent materials or coatings with low haze levels and other desirable optical or chemical properties. In one embodiment, the polymeric matrix incorporating the nano-scale particles forms a transparent film. By “transparent film”, it is meant that the film has a haze number when measuring visible light transmission that is less than about 5% as determined in accordance with ASTM D-1003. For example, coatings or films incorporating nano-scale particles according to the present disclosure have a haze of about lower or equal to 0.5 to about 3.0 when measured in accordance with ASTM D1003. The coating is also normally transparent as determined by ASTM D1003.

While the above has been described with respect to transparent films, opaque films and films containing pigments or fillers is also contemplated for use with the nano-scale particle containing polymer materials according to embodiments of the disclosure.

The nano-scale particle containing dispersions can be added to the polymeric matrix material by any suitable method. Examples of suitable methods, include, but are not limited to shaking, stirring, milling/dispersing processes, dynamic, static mixers or other blending techniques.

Coatings containing nano-scale particles according to the present disclosure may be applied to any suitable substrate. Suitable substrates include a wide range of substrates such as wood, plastic, metal, ceramic, glass, paper, films and other common substrates. Examples of suitable substrates include, but are not limited to at least one member selected from the group consisting of glass, metal, polymeric substrates, e.g. polycarbonate (PC), polymethyl methacrylate (PMMA), polyethylene terephthalate (PET), polyvinyl chloride (PVC), polyethylene (PE), polypropylene (PP), polyvinyl butyral (PVB), polyamide (PA), polyesters, polyamides, epoxy, polyurethanes, and siloxanes, wood, cotton, linen, wool, textiles, nonwovens, among other suitable substrates and combinations thereof.

If desired the nano-scale particle containing material or coating can include at least one additive such as wetting agents, surfactants, defoamers, and other additives used to formulate inks, coatings and adhesives.

In certain embodiments of the present disclosure, the thickness of the coating containing the nano-scale particles, after curing or drying, can range from about 2 to about 1,000 microns. In other embodiment, the thickness of the coating may range from about 2 to about 500 microns or 10 to 250 microns. In one aspect of the disclosure, a coating composition containing nano-scale ZnO produces a transparent film.

The inventive formulations can be prepared by any conventional method such as combining a dispersion of particles into a coating formula by mixing, grinding, milling, or other common mixing and dispersing techniques. The coating formulations can be applied by any suitable method such as spraying, dipping, brushing, rolling, or other common coating, ink, and adhesive application processes. The applied formulations can be cured or dried using any suitable method such as ambient air dry, heat, IR heating, UV or EB curing, forced air drying and other common methods for drying and curing coatings, and combinations thereof.

Other embodiments may include nano-scale particle containing polymeric materials for use as coatings, adhesives, films, sealants, inks, elastomeric systems, among other uses.

The following examples are set forth to assist in understanding the invention and do not limit the invention described and claimed herein. Such variations of the invention, including the substitution of all equivalents now known or later developed, which would be within the purview of those skilled in the art, and changes in formulations or minor changes in experimental design, fall within the scope of the present invention.

### EXAMPLES

The following Table 1 lists the product name, chemical name and supplier of the materials used in the Examples.

TABLE 1

| PRODUCT NAME | CHEMICAL NAME | DESCRIPTION | SUPPLIER |
|---|---|---|---|
| EPON ® 828 | bisphenol A diglycydal ether | liquid epoxy resin | Hexion |
| | | | Specialty |
| | | | Chemicals |
| ANCAMINE ® 2143 | cycloaliphatic amine | curative for epoxy resin | Air Products |
| | | | and Chemicals |
| | | | Inc. (APCI) |
| HYBRIDUR ® 570 | acrylic-urethane hybrid polymer | film former | APCI |
| HYBRIDUR ® 870 | acrylic-urethane hybrid polymer | film former | APCI |
| HYBRIDUR ® 878 | acrylic-urethane hybrid polymer | film former | APCI |
| NeoRez ® R-9637 | urethane dispersion | film former | DSM |
| | | | NeoResins |
| NeoPac R-9699 | urethane/acrylic copolymer | film former | DSM |
| | | | NeoResins |
| Rhoplex ® SG-10 | acrylic polymer | film former | Rohm & Haas |
| AIRFLEX ® 426 | ethylene-vinyl acetate copolymer | film former | APCI |
| Butyl Cellosolv | ethylene glycol n-butyl ether | cosolvent | Sigma-Aldrich |
| Butyl Carbitol | diethylene glycol butyl ether | cosolvent | Sigma-Aldrich |
| DPnB | dipropylene glycol n-butyl ether | cosolvent | Sigma-Aldrich |
| PnB | propylene glycol n-butyl ether | cosolvent | Sigma-Aldrich |
| TEXANOL ® | ester alcohol | cosolvent | Eastman |
| AMP 95 | 2 amino, 2 methyl, 1 propanol | basic ph neutralizing agent | Angus |
| | | | chemical |
| BYK ®-346 | polyether modified poly- | silicone surfactant | BYK Chemie |
| | dimethyl-siloxane | | |
| DEE FO ® PI-4 | polyalkalene glycol | defoamer | Ultra Additives |
| BYK ® 333 | polyether modified | surfactant | BYK Chemie |
| | polymethylsiloxane | | |
| Envirogem ® AD01 | alkane diol | surfactant | APCI |
| BYK ® 024 | polysiloxane | defoamer | BYK Chemie |
| Nano ZnO S44Z | aqueous dispersion of zinc oxide | dispersion of zinc oxide particles | APCI |
| | particles, particle size d50 = | | |
| | 48 nm | | |
| Nano ZnO | PIBSA containing dispersion of | dispersion of zinc oxide particles | APCI |
| | zinc oxide particles - according | | |
| | to U.S. Patent Application Nos. | | |
| | 60/898,554 and 60/898,555 | | |
| | (Docket Nos. 6931Z and 7059Z), | | |
| | both filed on Jan. 31, 2007 | | |
| | particle size d50 = 57 nm | | |
| Nano ZnO XZ0008 | dispersion of zinc oxide | dispersion of zinc oxide particles | APCI |
| | particles, particle size d50 = | | |
| | 54 nm | | |
| NANOBYK ®-3820 | | dispersion of zinc oxide particles | BYK Chemie |
| NANOBYK ®-3840 | | dispersion of zinc oxide particles | BYK Chemie |
| NANOBYK ®-3860 | | dispersion of zinc oxide particles | BYK Chemie |
| Flexthane VRAL1 | urethane dispersion | film former | APCI |

### Examples 1-7

The following formulations were prepared by mechanically combining the ingredients in a suitable mixing container while under mild agitation.

TABLE 2
Formulations (ingredients concentrations noted in parts by weight)

| Example | 1 | 2 | 3 | 4 | 5 | 6 | 7 |
|---|---|---|---|---|---|---|---|
| Mix these first 2 | | | | | | | |
| ingredients - | | | | | | | |
| “PREMIX” | | | | | | | |
| DPnB | 9.83 | 9.83 | 9.83 | 9.83 | 9.83 | 9.83 | 9.83 |
| BYK ®-346 | 0.44 | 0.44 | 0.44 | 0.44 | 0.44 | 0.44 | 0.44 |
| Total Pre-Mix | 10.27 | 10.27 | 10.27 | 10.27 | 10.27 | 10.27 | 10.27 |
| Mix in the | | | | | | | |
| following in order | | | | | | | |
| HY570 | 74.23 | 74.23 | 74.23 | 74.23 | 74.23 | 74.23 | 74.23 |
| DPnB/BYK ®-346 | 10.27 | 10.27 | 10.27 | 10.27 | 10.27 | 10.27 | 10.27 |
| “Premix” | | | | | | | |
| Dee Fo PI-4 | 0.22 | 0.22 | 0.22 | 0.22 | 0.22 | 0.22 | 0.22 |
| Nano ZnO S44Z | — | 3.50 | 7.01 | 12.27 | — | — | — |
| NANOBYK ®-3820 | — | — | — | — | 2.80 | — | — |
| (BYK ® ZnO | | | | | | | |
| dispersion) | | | | | | | |
| NANOBYK ®-3840 | — | — | — | — | — | 2.87 | — |
| (BYK ® ZnO | | | | | | | |
| dispersion) | | | | | | | |
| NANOBYK ®-3860 | — | — | — | — | — | — | 2.29 |
| (BYK ® ZnO | | | | | | | |
| dispersion) | | | | | | | |
| Water | 15.28 | 12.41 | 9.53 | 5.22 | 13.74 | 13.67 | 14.25 |
| Total Formulation | 100.00 | 100.63 | 101.26 | 102.21 | 101.26 | 101.26 | 101.26 |

These formulas were applied to zinc phosphated steel panels (Bonderite® 952) using wire wound rod manufactured by R.D. Specialties, RDS 70, which provided a wet film thickness of approximately 6.3 mils (0.0063 inches). The applied coatings were dried at room temperature (70 F, 50% RH) for at least 7 days. The dry film thickness of the films was 2.0 mils (0.002 inches). The properties of the coatings were evaluated by the methods noted in Table 3 and test results from these evaluations are provided in Table 4 below.

In addition to these properties, the inventive coatings were evaluated for their ability to improve weathering, principally UV resistance. Panels were prepared by applying a weather resistant 2-component gloss white polyurethane coating (Rustoleum® High Performance Industrial Low VOC Urethane 9700 system gloss white) onto zinc phosphated steel panels (Bonderite® 952). An epoxy clearcoat formulation was then prepared:

| EPON ® 828 | 100 parts by weight |
|---|---|
| Toluene | 44.8 |
| BYK ® 333 | 0.60 |
| ANCAMINE ® 2143 | 60.0 |

After allowing the white polyurethane coating to dry for a suitable period (e.g., 7 days at room temperature, or some equivalent cure schedule at elevated temperature), the epoxy clear coating was applied using an RDS rod number 44, approximate wet film thickness of 4 mils. The epoxy coating was cured at room temperature for approximately 16 hours, followed by curing for approximately 16 hours at 43° C. Then, panels with the polyurethane white coating and the epoxy clear overcoat were coated with coatings listed in Table 2 using wire wound rod manufactured by RDS, rod number 70. These coating systems were dried for 5 hours at room temperature, followed by approximately 16 hours at 43° C. After drying, these coated panels were placed in a QUV-A chamber with only light exposure (no water, condensation or humidity). The coated panels (3 coat system) were periodically evaluated for gloss and color change. The Test Procedures are listed in Table 3. The data presented in Table 4 were measured following 4000 hours exposure in QUV-A.

TABLE 3
Performance Test Procedures

| Example | Method |
|---|---|
| GLOSS - White Leneta (20°) | ASTM D523 |
| GLOSS - White Leneta (60°) | ASTM D523 |
| GLOSS - White Leneta (85°) | ASTM D523 |
| GLOSS - Black Leneta (20°) | ASTM D523 |
| GLOSS - Black Leneta (60°) | ASTM D523 |
| GLOSS - Black Leneta (85°) | ASTM D523 |
| CONTRAST RATIO (y black/y white) | |
| DRY SCRAPE | ASTM D2197 |
| WET SCRAPE (24 HR/RT) | ASTM D2197 |
| DRY TAPE | ASTM D3359 |
| WET TAPE (24 HR/RT) | ASTM D3359 |
| WATER IMMERSION (24 HR/RT) | |
| HUMIDITY (100° F./100% RH) | ASTM D4585 |
| IPA double rubs | ASTM D4752 |
| TOLUENE double rubs | ASTM D4752 |
| MEK double rubs | ASTM D4752 |
| GARDNER IMPACT (in./lbs.) Direct | ASTM D2794 |
| GARDNER IMPACT (in./lbs.) Reverse | ASTM D2794 |
| PERSOZ HARDNESS | ASTM D4366/ANS/ISO 1522 |
| PENCIL HARDNESS | ASTM D3363 |
| QUV-A 4000 hr exposure; color change | QUV -A ASTM D4587 |
| ΔE color change (3 coat system) | |
| QUV-A 4000 hr exposure; 20 deg gloss | QUV -A ASTM D4587 |
| retention (3 coat system) | |

TABLE 4
Performance and Testing Data

| Example | 1 | 2 | 3 | 4 | 5 | 6 | 7 |
|---|---|---|---|---|---|---|---|
| GLOSS - White (20°) | 67.7 | 65.9 | 59.5 | 63.4 | 61.3 | 63.2 | 61.9 |
| GLOSS - White (60°) | 88.4 | 88.0 | 87.9 | 88.4 | 87.6 | 87.5 | 86.8 |
| GLOSS - White (85°) | 97.3 | 97.3 | 96.8 | 97.1 | 97.2 | 96.8 | 96.5 |
| GLOSS - Black (20°) | 71.0 | 62.6 | 64.2 | 64.3 | 66.3 | 64.7 | 61.7 |
| GLOSS - Black (60°) | 86.6 | 85.7 | 85.8 | 85.9 | 85.7 | 84.5 | 84.5 |
| GLOSS - Black (85°) | 97.2 | 97.3 | 97.2 | 96.9 | 97.1 | 97 | 97 |
| CONTRAST RATIO (y black/y | 0.0075 | 0.0082 | 0.0094 | 0.0112 | 0.015 | 0.0172 | 0.0247 |
| white) | | | | | | | |
| DRY SCRAPE | pass 3.0 | pass 3.0 | pass 2.5 | pass 2.5 | Pass 2.5 | Pass 2.5 | Pass 2.5 |
| WET SCRAPE (24 HR/RT) | pass 1.5 | pass 2.0 | pass 1.0 | pass 1.0 | Pass 2.5 | Pass 1.5 | Pass 2.0 |
| DRY TAPE | 5A | 5A | 5A | 5A | 5A | 5A | 5A |
| WET TAPE (24 HR/RT) | 5A | 5A | 5A | 5A | 5A | 5A | 5A |
| WATER IMMERSION (24 HR/ | Pass | Pass | Pass | Pass | Pass | Pass | Pass |
| RT) | | | | | | | |
| HUMIDITY (100° F./100% RH) | Fail at | Pass at | Pass at | Pass at | Pass at | Pass at | Pass at |
| | 1 day | 30 days | 30 days | 30 days | 30 days | 30 days | 30 days |
| IPA double rubs | 92 | 200 | 200 | 200 | 200 | 200 | 200 |
| TOLUENE double rubs | 200 | 200 | 200 | 200 | 200 | 200 | 200 |
| MEK double rubs | 200 | 200 | 200 | 200 | 200 | 200 | 200 |
| GARDNER IMPACT (in./lbs.) | 160 | 160 | 144 | 152 | 160 | 160 | 160 |
| Direct | | | | | | | |
| GARDNER IMPACT (in./lbs.) | 160 | 160 | 160 | 160 | 160 | 160 | 160 |
| Reverse | | | | | | | |
| PERSOZ HARDNESS | 135 | 144 | 140 | 148 | 137 | 135 | 134 |
| PENCIL HARDNESS | 3B | B | HB | 2B | — | — | — |
| QUV-A 4000 hr exposure; | 52.77 | 58.25 | 43.07 | 6.13 | 38.56 | 38.21 | 38.12 |
| color change ΔE (3 coat | | | | | | | |
| system) | | | | | | | |
| QUV-A 4000 hr exposure; 20 | 56.9 | 54.1 | 98.6 | 100.0 | 100.0 | 100.0 | 91.1 |
| deg gloss retention (3 coat | | | | | | | |
| system) | | | | | | | |

The data presented in Table 4 demonstrates that the ZnO sub-micron particles cause a significant improvement in IPA double rub resistance, humidity resistance, and UV resistance.

### Examples 8-9

IPA resistance evaluations were performed with and without sub-micron ZnO particles in a commercial polyurethane dispersion (PUD NeoRez® R-9637 manufactured by DSM NeoResins). The following formulas were prepared, applied, and cured in accordance with Examples 1-7. Example 8 failed at 100 IPA double rubs and Example 9 passed >200 IPA double rubs.

TABLE 5

| Example | 8 | 9 |
|---|---|---|
| PnB | 2.45 | 2.45 |
| DPnB | 2.45 | 2.45 |
| NeoRez ® R-9637 | 45.09 | 45.09 |
| Nano ZnO S44Z | — | 3.62 |
| Water | 15.00 | 12.03 |
| Total Formulation | 62.54 | 63.19 |

### Examples 10-11

IPA resistance evaluations were performed with and without sub-micron ZnO in a commercial polyurethane-acrylic hybrid dispersion (NeoPac® R-9699 manufactured by DSM NeoResins). The following formulas were prepared, applied, and cured in accordance with Examples 1-7. Example 10 failed at 150 IPA double rubs and Example 11 passed >200 IPA double rubs.

TABLE 6

| Example | 10 | 11 |
|---|---|---|
| Butyl cellosolve | 3.07 | 3.07 |
| Butyl carbitol | 3.07 | 3.07 |
| NeoPac R-9699 | 43.86 | 43.86 |
| Nano ZnO S44Z | — | 3.90 |
| Water | 15.00 | 11.80 |
| Total Formulation | 65.00 | 65.70 |

### Examples 12-26

The formulations noted in the examples below were prepared by mechanically combining the ingredients in a suitable container while under mild agitation. These formulas were applied to zinc phosphated steel panels (Bonderitee 952) using wire wound rod RDS 70, which provided a wet film thickness of approximately 6.3 mils (0.0063 inches). The applied coatings were dried at room temperature (70° F. (21° C.), 50% RH) for at least 7 days. The dry film thickness of the films was about 1.3 to about 1.8 mils (0.0013 to 0.0018 inches). After allowing to dry for 7 or more days at ambient room temperature, the properties of the coatings were evaluated by the methods ASTM D4752 IPA double rub resistance and ASTM D4585 humidity resistance.

TABLE 7
Formulations (ingredients concentrations noted in parts by weight)

| Example | 12 | 13 | 14 | 15 |
|---|---|---|---|---|
| PRE-MIX | | | | |
| DPnB | 2.50 | 2.50 | 2.50 | 2.50 |
| Envirogem ® | 2.00 | 2.00 | 2.00 | 2.00 |
| AD01 | | | | |
| BYK ®-346 | 0.05 | 0.05 | 0.05 | 0.05 |
| BYK ®-024 | 0.10 | 0.10 | 0.10 | 0.10 |
| Total Pre-Mix | 4.65 | 4.65 | 4.65 | 4.65 |
| Mix in the | | | | |
| following order | | | | |
| HY870 | 100.00 | 100.00 | 100.00 | 100.00 |
| (polyurethane- | | | | |
| acrylic hybrid) | | | | |
| Nano ZnO S44Z | — | 8.33 | — | — |
| Nano ZnO | — | — | 5.84 | — |
| Nano ZnO | — | — | — | 9.76 |
| XZ0008 | | | | |
| Water | 2.10 | — | — | — |
| Total | 106.75 | 112.98 | 110.49 | 114.41 |
| Formulation | | | | |

Example 12 failed at 100 IPA double rubs. Examples 13, 14, and 15 passed ≧200 IPA double rubs. Example 12 failed by blistering in humidity resistance in less than 24 hours. Examples 13, 14, and 15 after 30 days exposure showed only minor rusting of the steel substrate but no blistering of the coating.

TABLE 8
Formulations (ingredients concentrations noted in parts by weight)

| Example | 16 | 17 | 18 | 19 |
|---|---|---|---|---|
| PRE-MIX | | | | |
| DPnB | 10.00 | 10.00 | 10.00 | 10.00 |
| Envirogem ® | 4.25 | 4.25 | 4.25 | 4.25 |
| AD01 | | | | |
| BYK ®-346 | 0.05 | 0.05 | 0.05 | 0.05 |
| BYK ®-024 | 0.10 | 0.10 | 0.10 | 0.10 |
| Total Pre-Mix | 14.40 | 14.40 | 14.40 | 14.40 |
| Mix in the | | | | |
| following order | | | | |
| HY878 | 100.00 | 100.00 | 100.00 | 100.00 |
| (polyurethane- | | | | |
| acrylic hybrid) | | | | |
| Nano ZnO S44Z | — | 8.33 | — | — |
| Nano ZnO | — | — | 5.84 | — |
| Nano ZnO | — | — | — | 9.76 |
| XZ0008 | | | | |
| Water | 10.00 | 10.00 | 10.00 | 10.00 |
| Total | 124.40 | 132.73 | 130.24 | 134.16 |
| Formulation | | | | |

Example 16 failed at 75 IPA double rubs. Examples 17, 18, and 19 passed ≧200 IPA double rubs. Example 16 failed by blistering in humidity resistance in less than 24 hours. Examples 17, 18, and 19 after 30 days exposure showed no rusting of the steel substrate or no blistering of the coating.

TABLE 9
Formulations (ingredients concentrations noted in parts by weight)

| Example | 20 | 21 | 22 |
|---|---|---|---|
| TEXANOL ® | 4.00 | 4.00 | 4.00 |
| Rhoplex ® SG-10 | 50.00 | 50.00 | 50.00 |
| (acrylic latex) | | | |
| Nano ZnO | — | 2.77 | 5.99 |
| Water | 4.60 | 3.97 | — |
| TOTAL | 58.60 | 60.74 | 59.99 |

Example 20 failed less than 100 IPA double rubs. Examples 21 and 22 passed ≧200 IPA double rubs.

TABLE 10
Formulations (ingredients concentrations noted in parts by weight)

| Example | 23 | 24 | 25 | 26 |
|---|---|---|---|---|
| AIRFLEX ® 426 (ethylene-vinyl | 100.00 | 100.00 | 100.00 | 100.00 |
| acetate co-polymer) | | | | |
| Water | 50.00 | 50.00 | 50.00 | 50.00 |
| adjust pH to 7 | | | | |
| AMP-95 | 0.44 | 0.44 | 0.44 | 0.44 |
| Nano ZnO S44Z | — | 13.13 | — | — |
| Nano ZnO | — | — | 15.09 | — |
| Nano ZnO XZ0008 | — | — | — | 15.37 |
| Total Formulation | 150.44 | 163.57 | 165.53 | 165.81 |

Example 23 failed less than 150 IPA double rubs. Examples 24, 25, and 26 passed ≧200 IPA double rubs.

### Examples 12-26

Flexthane® VRAL1 is a polyurethane dispersion supplied by APCI. The dried film has a Tg of −55° C. and is tacky at room temperature

The following formulations were prepared by mechanically combining the ingredients in a suitable mixing container while under mild agitation.

TABLE 11
Formulations (ingredients concentrations noted in parts by weight)

| Mix in the | Example | | | | | |
|---|---|---|---|---|---|---|
| following in order | 27 | 28 | 29 | 30 | 31 | 32 |
| Flexthane ® VRAL1 | 50.0 | 50.0 | 50.0 | 50.0 | 50.0 | 50.0 |
| Nano ZnO XZ0008 | — | 2.19 | 4.38 | 8.75 | — | — |
| Nano ZnO S44Z | — | — | — | — | 2.19 | 4.38 |
| Total Formulation | 50.0 | 52.19 | 54.38 | 58.75 | 52.19 | 54.38 |

These formulas were applied to polyethelene terephthalate (PET) film using a drawdown bar, which provided a wet film thickness of approximately 6 mils (0.006 inches). The applied coatings were dried in 50° C. nitrogen purged oven for one hour then at room temperature (70 F, 50% RH) for at least 7 days. The dry adhesive film thickness of the films was 2.0 mils (0.002 inches).

The adhesive films were tested with Dynamic Mechanical Analyzer (DMA) to determine change of visco-elastic properties with the addition of nano ZnO. The sample was layered and was cut using an 8 mm die. Samples were tested between 8 mm diameter stainless steel parallel plates zeroed at −20° C. Samples were loaded at room temperature and were placed under compressive force to affix samples to the plates. The compressive force was removed and the samples were cooled slowly to −20° C. Data were collected at temperatures between −20° and 120° C. in 10° C. isothermal steps at an oscillation frequency of 0.1 Hz using an RDA III controlled-strain rheometer. All measurements were made in the linear viscoelastic region. A small compressive force of 10 grams was placed on the sample to maintain contact with the plates and allow for thermal expansion of the samples and plates.

The Storage modulus (G′) of films are shown in the following table 12 and loss modulus (G″) in Table 13. Both the storage and loss modulus increases with increasing nano ZnO concentration.

TABLE 12
Storage modulus (G′) of Flexthane ® VRA films with nano ZnO in dyn cm⁻²

| Temp, | | | | | | |
|---|---|---|---|---|---|---|
| ° C. | Example 27 | Example 28 | Example 29 | Example 30 | Example 31 | Example 32 |
| 50 | 7.37E+05 | 1.99E+06 | 2.14E+06 | 3.34E+06 | 8.48E+05 | 2.15E+06 |
| 60 | 2.97E+05 | 9.69E+05 | 1.21E+06 | 2.36E+06 | 4.00E+05 | 1.29E+06 |
| 70 | 9.36E+04 | 4.08E+05 | 6.05E+05 | 1.55E+06 | 1.65E+05 | 7.02E+05 |
| 80 | 2.60E+04 | 1.45E+05 | 2.56E+05 | 9.19E+05 | 5.19E+04 | 3.34E+05 |
| 90 | 5.51E+03 | 3.71E+04 | 8.44E+04 | 4.52E+05 | 1.10E+04 | 1.23E+05 |
| 100 | 2.45E+03 | 1.15E+04 | 2.08E+04 | 1.66E+05 | 6.36E+03 | 3.66E+04 |

TABLE 13
Loss modulus (G″) of Flexthane ® VRA films with nano ZnO in dyn cm⁻²

| Temp, | | | | | | |
|---|---|---|---|---|---|---|
| ° C. | Example 27 | Example 28 | Example 29 | Example 30 | Example 31 | Example 32 |
| 50 | 7.26E+05 | 1.24E+06 | 1.28E+06 | 1.39E+06 | 6.75E+05 | 1.10E+06 |
| 60 | 4.15E+05 | 8.34E+05 | 9.33E+05 | 1.22E+06 | 4.55E+05 | 8.32E+05 |
| 70 | 2.10E+05 | 5.19E+05 | 6.52E+05 | 9.95E+05 | 2.64E+05 | 6.28E+05 |
| 80 | 9.89E+04 | 2.74E+05 | 3.89E+05 | 7.72E+05 | 1.31E+05 | 4.11E+05 |
| 90 | 4.06E+04 | 1.24E+05 | 1.95E+05 | 5.23E+05 | 6.02E+04 | 2.39E+05 |
| 100 | 1.71E+04 | 4.93E+04 | 7.98E+04 | 2.94E+05 | 2.47E+04 | 1.22E+05 |

The Haze of the coatings formed in accordance with Examples 3, 4, 5, 6, and 7 was determined by using a spectrophotometer according to ASTM Method D-1003. The results of this determination are listed in Table 14.

TABLE 14
Haze Analysis

| | |
|---|---|
| Example 3 | 1.0335% |
| Example 4 | 1.2975% |
| Example 5 | 5.4653% |
| Example 6 | 10.8824% |
| Example 7 | 36.9174% |

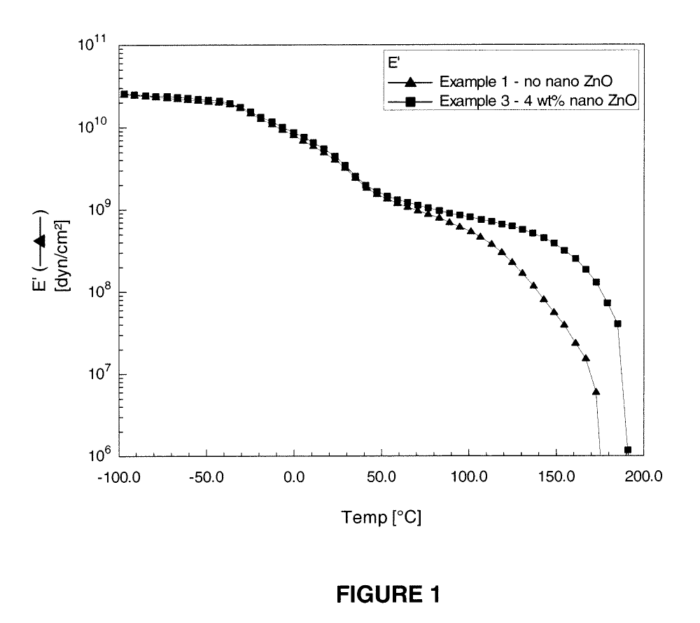

As shown in FIG. 1, Dynamic Mechanical Analysis (DMA) was measured on samples formed with the formulation of Example 1 and Example 3. Example 1 sample include no nano-scale ZnO and Example 3 sample includes 4 wt % nano-scale ZnO. Dynamic mechanical properties were measured using a TA Instruments (formerly Rheometric Scientific) RSA II controlled strain rheometer in a film tension geometry. Data were collected between temperatures of −97° and 200° C. at an applied oscillation frequency of 6.28 rad/sec (1 Hz). The temperature ramp rate was 5° C./min; data were collected at 30 sec intervals. All data were collected in the linear viscoelastic region. Sample dimensions were approximately 22 mm in length, 6.4 mm in width, and 0.07 mm in thickness. FIG. 1 illustrates the storage modulus (E′) Examples 1 and 3. Both films have similar glassy regions from −100° C. to −50° C., and then a broad glass transition temperature from −50° C. to about 30° C. At temperatures above 60° C., the modulus of the Example 1 sample begins to drop while that of the nano-ZnO filled system has an extended rubbery region. A rubbery plateau in this section of the DMA, especially one that increases in modulus, is indicative of a crosslinked system. The E′ for the Example 3 sample decreases at approximately 40-50° C. higher than that of the Example 1 sample, indicating at least partial crosslinking, including crosslinking from bonding, such as, but not limited to, ionic bonding.

Insoluble or gel content was measured on the Example 1 sample and the Example 3 sample. Insolubles were measured using a Soxhlet extraction apparatus, wherein a cast film of a preselected thickness was cast onto a polytetrafluoroethylene sheet and permitted to dry. A portion of the dried film is placed in the Sohlet extraction apparatus with solvent and an extraction is performed. The remaining insoluble film is weighed and data is recorded. The insolubles content of the Example 1 sample in IPA was 23%. The insolubles content of the Example 3 sample was 57%. The difference in insolubles illustrates a significant increase in insolubles, which indicates at least partial crosslinking.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An aqueous polymeric coating composition comprising:
a polymer for forming a polymer matrix having carboxylate functionality;
nano-scale zinc oxide particles dispersed in the polymer; and
wherein the particles provide the polymer with at least partial crosslinking and alcohol resistance when incorporated into the polymer matrix upon curing.

2. The composition of claim 1, wherein the particle size of the nano-scale particles is from about 5 to about 500 nm.

3. The composition of claim 1, wherein the composition is substantially transparent.

4. The composition of claim 1, wherein the composition includes a pigment.

5. The composition of claim 1, wherein the particles comprise from about 0.1 to about 70 wt % by weight of polymer solids of the composition.

6. The composition of claim 1, wherein the polymer dispersion is selected from the group consisting of acrylic, polyurethane, acrylic-urethane hybrids, polyureas, vinyl acetate, ethylene-vinyl acetate, ethylene vinyl chloride, vinyl acetate-acrylic, epoxy, alkyds, cellulose, silicones, silanes, melamines, polyethers, and polyesters.

7. The composition of claim 1, wherein the polymer comprises acrylic-urethane hybrid.

8. A polymeric material comprising:
a polymer matrix having carboxylate functionality;
nano-scale zinc oxide particles incorporated into the polymer matrix; and
wherein the particles provide the material with at least partial crosslinking and alcohol resistance when incorporated into the polymer matrix.

9. The material of claim 8, wherein the particle size of the nano-scale particles is from about 5 to about 500 nm.

10. The material of claim 8, wherein the material is substantially transparent.

11. The material of claim 8, wherein the material is opaque.

12. The material of claim 8, wherein the particles comprise from about 0.1 to about 70 wt % by weight of polymer solids of the material.

13. The material of claim 8, wherein the polymer matrix is selected from the group consisting of acrylic, polyurethane, acrylic-urethane hybrids, polyureas, vinyl acetate, ethylene-vinyl acetate, ethylene vinyl chloride, vinyl acetate-acrylic, epoxy, alkyds, cellulose, silicones, silanes, melamines, polyethers, and polyesters.

14. The material of claim 8, wherein the polymer matrix comprises acrylic-urethane hybrid.

15. A coated article comprising:
a substrate;
a polymeric coating disposed on the substrate comprising:
a polymer matrix having carboxylate functionality;
nano-scale zinc oxide particles incorporated into the polymer matrix; and
wherein the particles provide the material with at least partial crosslinking and alcohol resistance when incorporated into the polymer matrix.

16. The article of claim 15, wherein the particle size of the nano-scale particles is from about 5 to about 500 nm.

17. The article of claim 15, wherein the material is substantially transparent.

18. The article of claim 15, wherein the material is opaque.

19. The article of claim 15, wherein the particles comprise from about 0.1 to about 70 wt % by weight of polymer solids of the coating.

20. The article of claim 15, wherein the polymer matrix is selected from the group consisting of acrylic, polyurethane, acrylic-urethane hybrids, polyureas, vinyl acetate, ethylene-vinyl acetate, ethylene vinyl chloride, vinyl acetate-acrylic, epoxy, alkyds, cellulose, silicones, silanes, melamines, polyethers, and polyesters.

21. The article of claim 15, wherein the polymer matrix comprises acrylic-urethane hybrid.

22. The article of claim 15, wherein the substrate is selected from the group consisting of wood, plastic, metal, ceramic, glass, paper and combinations thereof.
